(19) United States
(12) Patent Application Publication
(10) Pub. No.: US 2011/0198858 A1
(43) Pub. Date: Aug. 18, 2011

(54) APPARATUS FOR ENERGY PRODUCTION

(76) Inventor: Renato Bastos RIBEIRO, Porto-Alegre (BR)

(21) Appl. No.: 12/797,523

(22) Filed: Jun. 9, 2010

Related U.S. Application Data
(60) Provisional application No. 61/185,974, filed on Jun. 10, 2009.

(51) Int. Cl. H02K 7/18; F03G 7/10

(52) U.S. Cl. 290/1 C; 74/DIG. 9

(57) ABSTRACT

Apparatus for energy production comprises a motor and interconnected flywheel. The apparatus is capable of collecting the energy accumulated in the flywheel's rotary motion peaks, storing and accumulating energy from the flywheel for use when the energy is required.

### RELATED APPLICATION

This application claims the benefit of and priority to U.S. Provisional Application Ser. No. 61/185,974, filed Jun. 10, 2009, the contents of which are incorporated by reference herein in its entirety.

### BACKGROUND

The present disclosure relates to an apparatus for energy production by using forces of nature. The apparatus will collect, concentrate and accumulate the peaks of energy produced by a flywheel and make them available for use in a variety of applications.

### SUMMARY

The energy existing in a rotating flywheel is already known. A flywheel is a wheel that stores energy through the rotary motion (kinetic energy) for an indefinite period, based on the energy conservation law, where the wheel in motion tends to remain in motion, provided that being not subject to any opposite force. In the flywheel, mechanisms exist that override the opposite forces. Therefore, as long as such mechanisms remain intact, the flywheel will continue in rotary motion. The flywheel start up may be performed through energy power, by using an electric motor for this purpose, or can be done manually, when mechanical energy is used.

In the mechanical system, the energy is stored in an inertial flywheel (used to accumulate rotational mechanical energy) and returned to the system via a transmission system.

In this sense, when using a flywheels system to generate energy, the mechanical energy accumulated in some parts of the system is accumulated in at most one flywheel revolution, and returned to the system via transmission.

The aim of the present disclosure consists in providing an apparatus for energy production capable of collecting the energy accumulated in the flywheel's rotary motion peaks, storing and accumulating this energy for use only when it is really required.

To achieve the objective herein, the system comprises flywheels and pulleys that drive each other and transmit the energy generated by these components, entering a self-feeding state.

### DRAWINGS

The above-mentioned features and objects of the present disclosure will become more apparent with reference to the following description taken in conjunction with the accompanying drawings wherein like reference numerals denote like elements and in which:

FIG. 1 shows a perspective view for an embodiment of the apparatus for energy production.

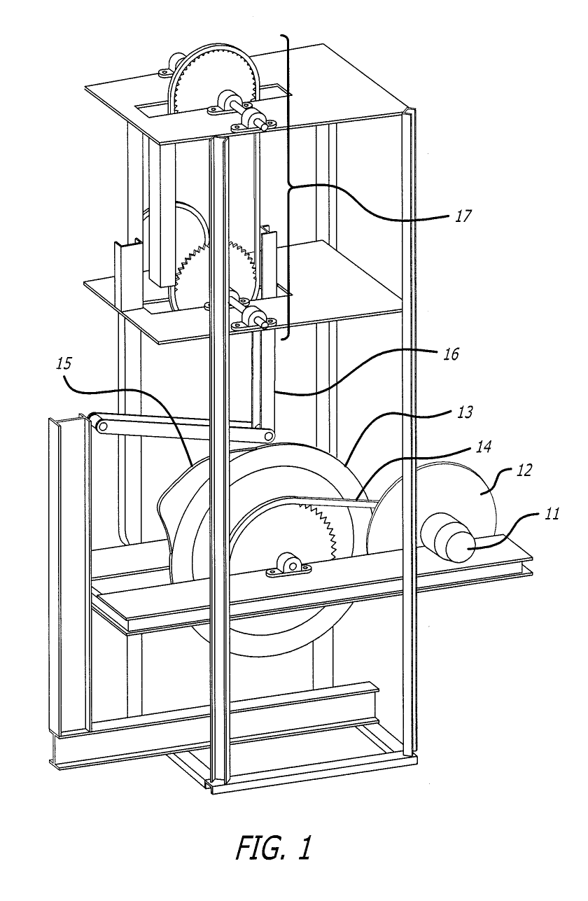

FIG. 2 shows a perspective view for a different embodiment of the apparatus for energy production.

FIG. 3 shows a perspective view for a different embodiment of the apparatus for energy production.

FIG. 4 shows a side view for an embodiment of the apparatus for energy production.

FIG. 5 shows a side view for an embodiment of the apparatus for energy production.

FIG. 6 shows a side view for an embodiment of the apparatus for energy production.

### DETAILED DESCRIPTION

The apparatus for energy production (1) comprises a motor (11) that will start up a small auxiliary flywheel (12), which, in turn, will drive the large flywheel (13), being that the auxiliary flywheel (12) drives the large flywheel (13) through a pulley (14).

This large flywheel (13) has an energy collecting element (15) that transmits through the arm (16) the energy for moving an assembly (17), which comprises at least three gears and chains. This assembly (17) makes available one or more torque takeoffs for distributing the energy.

This torque stored in the assembly (17) has enough accumulated power for driving some other equipment or feeding back the motor (11), thus distributing the substantial energy surplus for different uses.

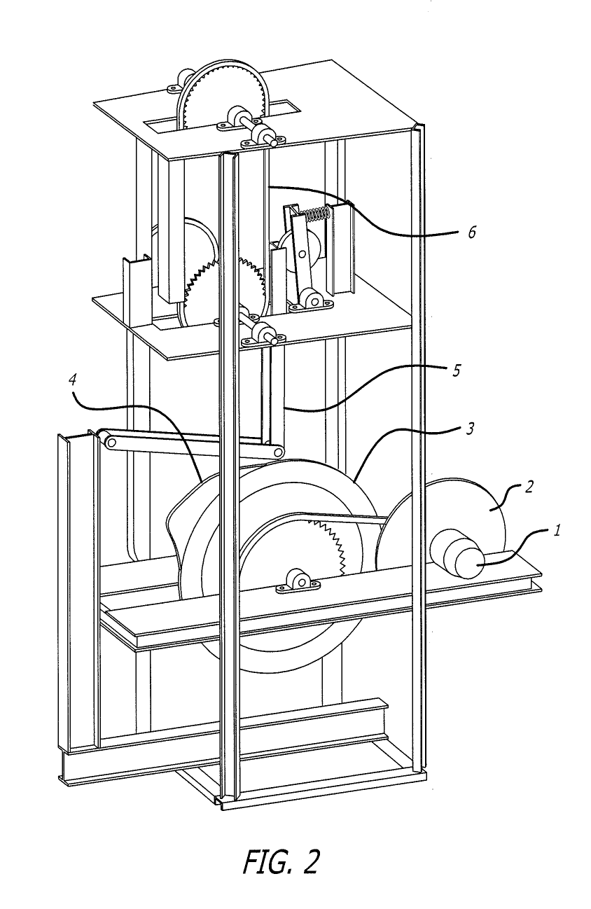

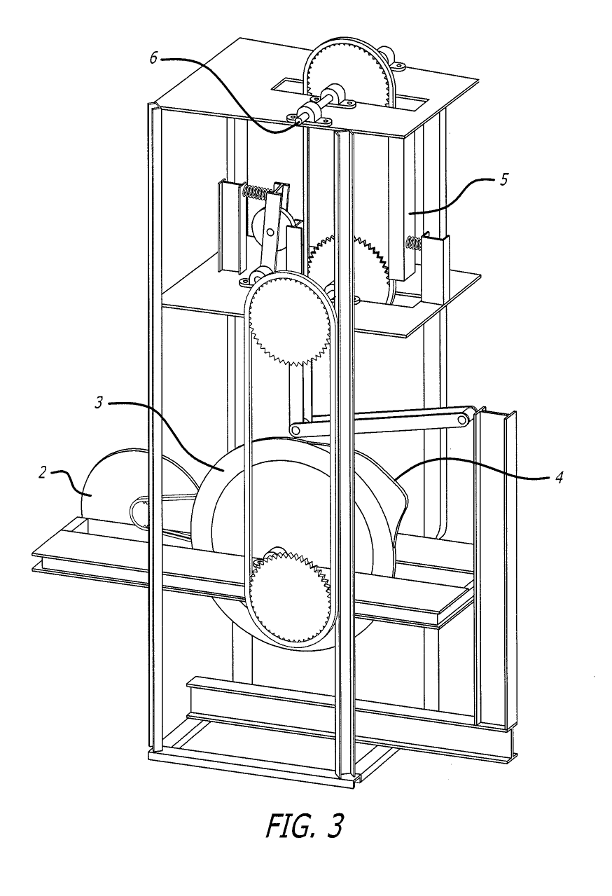

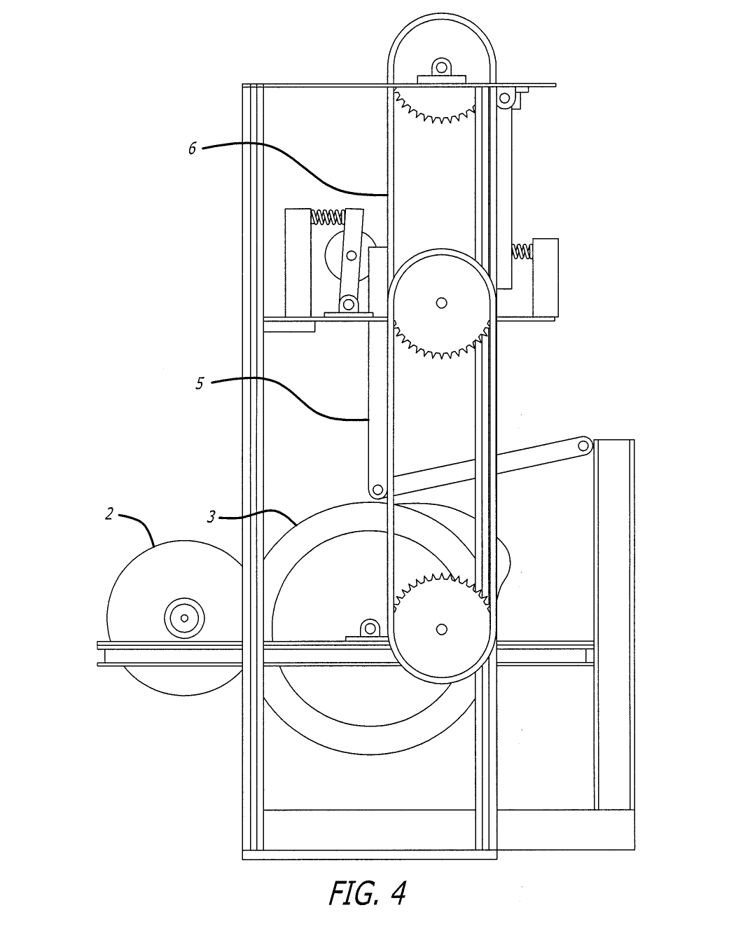

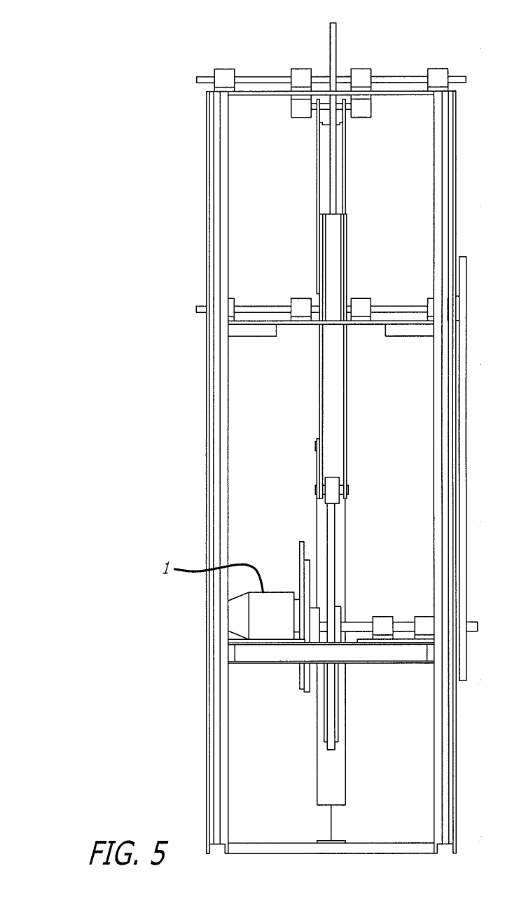

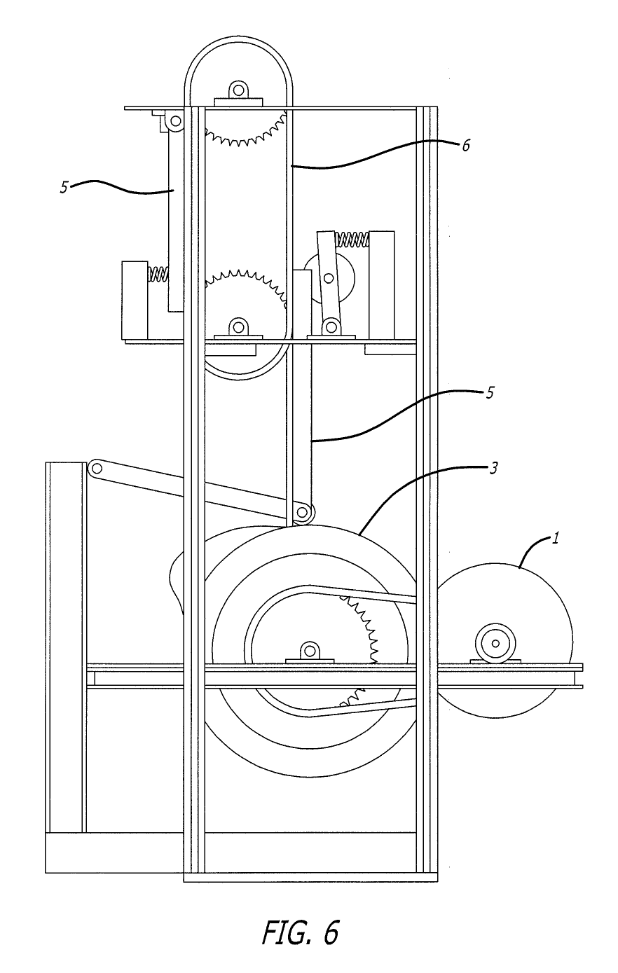

In FIGS. 2 to 6 different embodiments are shown with the motor fly with the number 1, a small auxiliary wheel 2 that activates the wheel 3.

Wheel 2 includes an element 4 to capture the energy of the wheel in fractional seconds. This element transmits, through an arm 5, the energy to move the set of gears and chain 6. This set makes one or more torque points available for the energy distribution. This torque that was made available has the power to easily feed the motor 1 and to distribute the substantial energy surplus to many different uses.

Therefore, after starting up the flywheel, it generates energy for self-feeding, and also a substantial energy surplus for use in several applications.

It shall be evident for experts in the art that the present disclosure may be configured in many other specific forms, without diverting from the spirit or the scope of the disclosure. Particularly, it shall be understood that the disclosure may be configured in the ways described.

Consequently, the present examples and configurations shall be deemed as illustrative, not restrictive, and the disclosure shall not be limited to the details given herein, but may be modified within the scope and equivalency of the claims attached hereinafter.

For instance, although the drawings illustrate three gears in assembly 17, there can be 1, 2 or 4 or even more gears. The assembly 17 is the transfer system through which he energy generated in the flywheel is be induced to other equipment, which utilizes the accumulated generated energy.

The energy collecting element 15 is an arm or a similar connecting element that pushes the element 16. The engine 11 connected to the wheel 12 generates kinetic energy. Considering that the wheel 12 is connected to the wheel 13, this kinetic energy is transported and increased to the wheel 13.

In the position where the element 15 is located, connected with the arm 16, where the energy concentration is higher. In this point the element 15, which is clutched in the 16 through a chain or another equivalent mean, pushes upward moving the set 17. The kinetic energy that is generated in the wheel 13 instead of continuing in the wheel is directed to the arm 16 and forwarded to the assembly 17 to be utilized in other equipment.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. Apparatus for energy production comprising a motor and interconnected flywheel, wherein the apparatus is capable of collecting the energy accumulated in the flywheel's rotary motion peaks, storing and accumulating energy from the flywheel for use when the energy is required.

2. Apparatus according to claim 1, comprising flywheels and pulleys that drive each other and transmit the energy generated by these components, and entering a self-feeding state.

3. Apparatus according to claim 1, comprising a large flywheel including an energy collecting element that transmits through an arm the energy for moving an assembly , the assembly including at least three gears and chains.

4. Apparatus according to claim 1, including an assembly for making available one or more torque takeoffs for distributing the energy.

5. Apparatus according to claim 1, wherein the torque stored in the assembly having enough accumulated power for driving some other equipment or feeding back the motor, thus distributing the substantial energy surplus for different uses.
